(19) United States
(12) Patent Application Publication
(10) Pub. No.: US 2015/0206412 A1
(43) Pub. Date: Jul. 23, 2015

(54) Scatterbrain

(71) Applicant: Steven Harold Lachance, Scottsdale, AZ (US)

(72) Inventor: Steven Harold Lachance, Scottsdale, AZ (US)

(21) Appl. No.: 13/999,143

(22) Filed: Jan. 21, 2014

(51) Int. Cl. G08B 21/18

(52) U.S. Cl. CPC G08B 21/182

(57) ABSTRACT

Scatterbrain is a lost and found machine designed for the household. A hand held controller instantly points in the direction of the lost item and displays distance to the lost item. The prior art of locating lost items around the house or apartment has been to search approximately a half dozen places the lost item may have been kept, maybe you find it and maybe you don't. Displaying both direction and distance to a lost item is a comprehensive unique way of finding lost items around the house or apartment.

### CROSS-REFERENCE TO RELATED APPLICATIONS

A cross-reference is being made at this time to provisional patent application No. 61/958,483 filed Jul. 29, 2013.

### STATEMENT REGARDING FEDERALLY SPONSORED RESEARCH OR DEVELOPMENT

Not Applicable

### BACKGROUND OF THE INVENTION

The fields of endeavor are organization, cataloging, lost and found. The patent classification and definitions that pertain to this invention is patent class #361—Electricity—Electrical systems and devices. Prior art of locating lost items around the house or apartment is to pick a half dozen places a particular item has been kept or found before, and begin your search. Maybe you find it, maybe you don't. Incorporating existing technologies to create a lost and found machine.

### BRIEF SUMMARY OF THE INVENTION

The substance/general idea of the invention in summarized form. Scatterbrain is a lost and found machine designed for the household. The advantages of the invention are that the hand held controller instantaneously displays direction and distance to a lost item. The invention solves previously existing problems of time consuming manual search. The object of the invention is to provide the convenience of an instantaneous display of direction and distance to a lost household item.

### BRIEF DESCRIPTION OF THE SEVERAL VIEWS OF THE DRAWING

FIG. 1 is an illustration that shows the hand held controller 5, antennas 30, 31, and a lost item eyeglasses 40. The electromagnet signature tag 34 is affixed to the eyeglasses 40. The pointer needles 25 are pointing to the selected item eyeglasses in the selected item window 15. The distance window 10 is displaying 15′, 15 feet is the distance the lost item 40 is from the hand held controller. The selected item knob 20 brings a selected item into the selected item window 15.

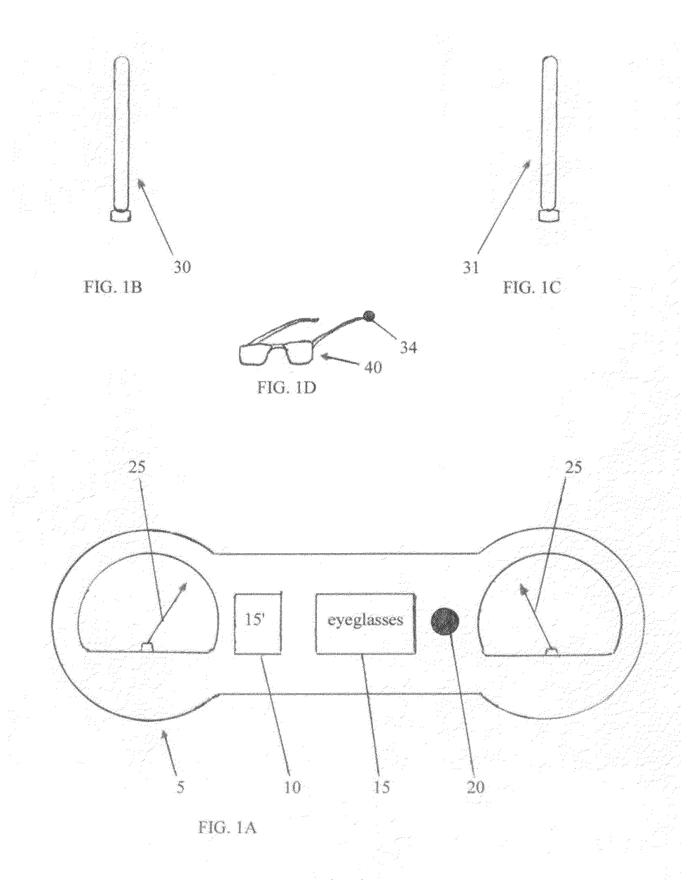

FIG. 2 is an illustration that shows the hand held controller 5, antennas 30, 31 and lost item i-phone 45. The electromagnetic signature tag 35 is affixed to the i-phone 45. The pointer needles 25 are pointing to the selected item i-phone in the selected item window 15. The distance window 10 is displaying 18′, 18 feet the is the distance lost item 45 is from the hand held controller. The selected item knob 20 brings a selected item into the selected item window 15.

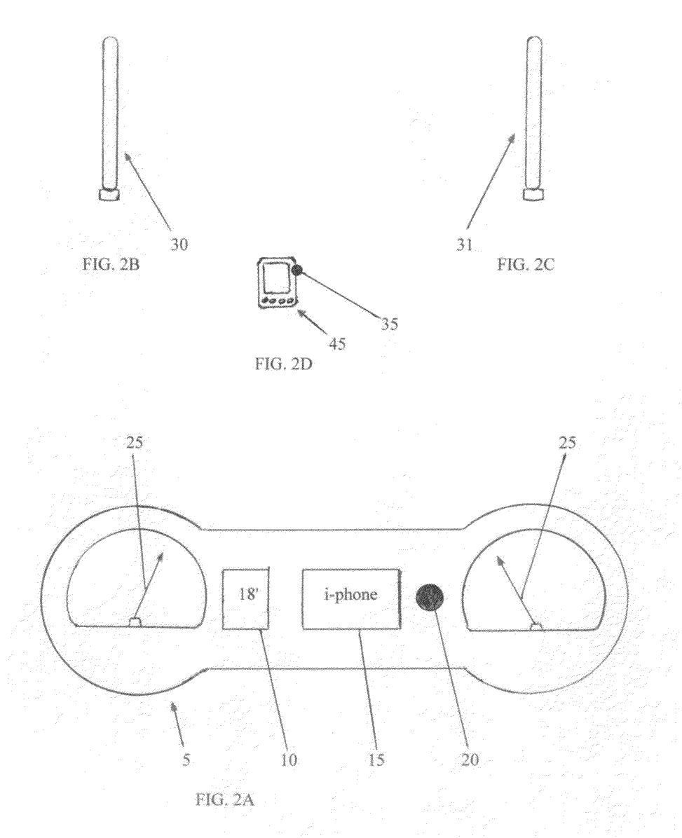

FIG. 3 is an illustration that shows the hand held controller 5, antennas 30, 31 and lost item passport 50. The electromagnetic signature tag 36 is affixed to the passport 50. The pointer needles 25 are pointing to the selected item passport in the selected item window 15. The distance window 10 is displaying 25′, 25 feet is the distance the lost item 50 is from the hand held controller. The selected item knob 20 brings a selected item into the selected item window 15.

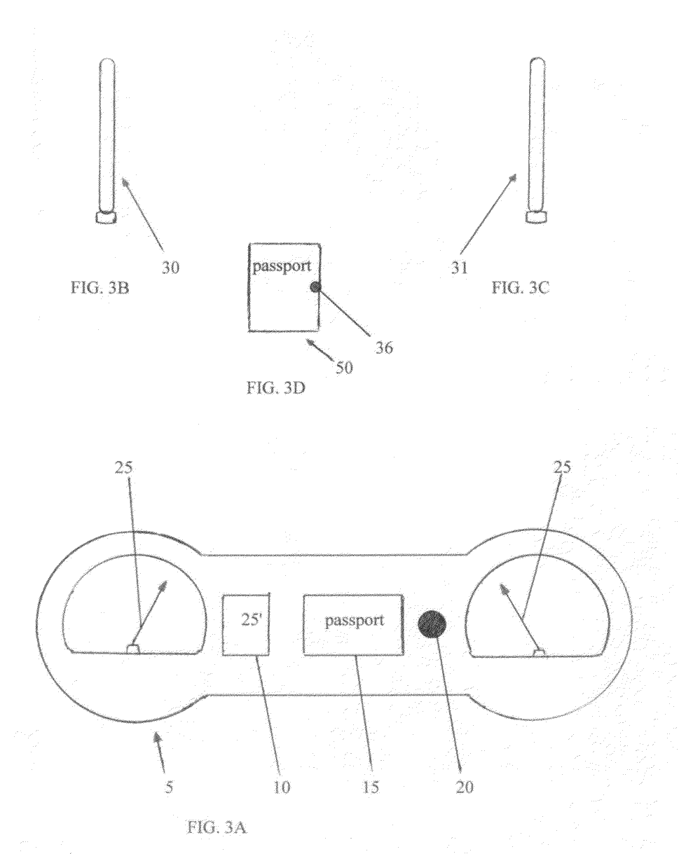

FIG. 4 is an illustration that shows the hand held controller 5, antennas 30, 31 and lost item house keys 55. The electromagnetic signature tag 37 is affixed to the house keys 55. The pointer needles 25 are pointing to the selected item house keys in the selected item window 15. The distance window 10 is displaying 21′, the distance the lost item 55 is from the hand held controller. The selected item knob 20 brings a selected item into the selected item window 15.

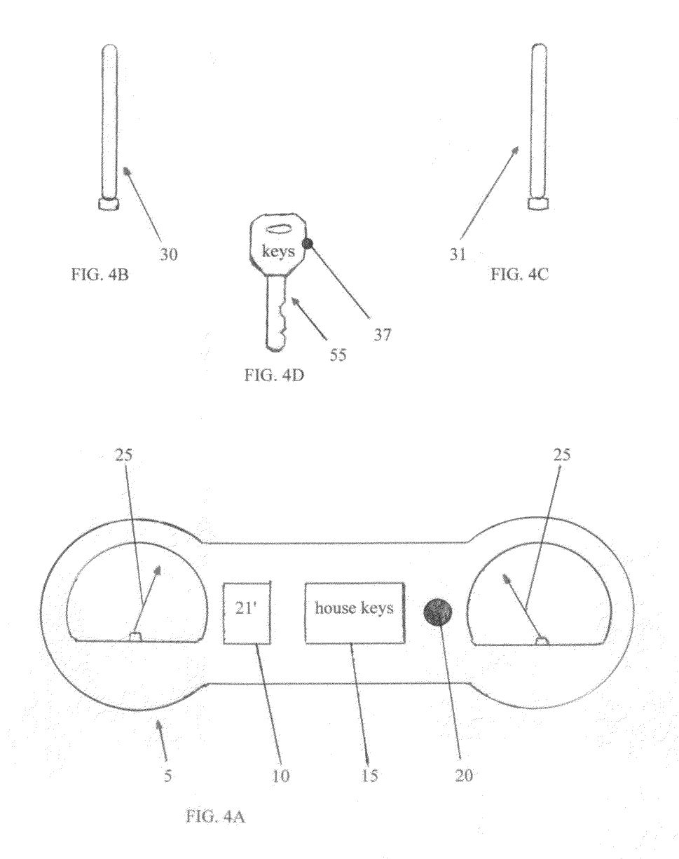

FIG. 5 is an illustration that shows the hand held controller 5, antennas 30, 31 and lost item medical kit 60. The electromagnetic signature tag 38 is affixed to the medical kit 60. The pointer needles 25 are pointing to the selected item medical kit in the selected item window 15. The distance window 10 is displaying 18′, the distance the lost item 60 is from the hand held controller. The selected item knob 20 brings a selected item into the selected item window 15.

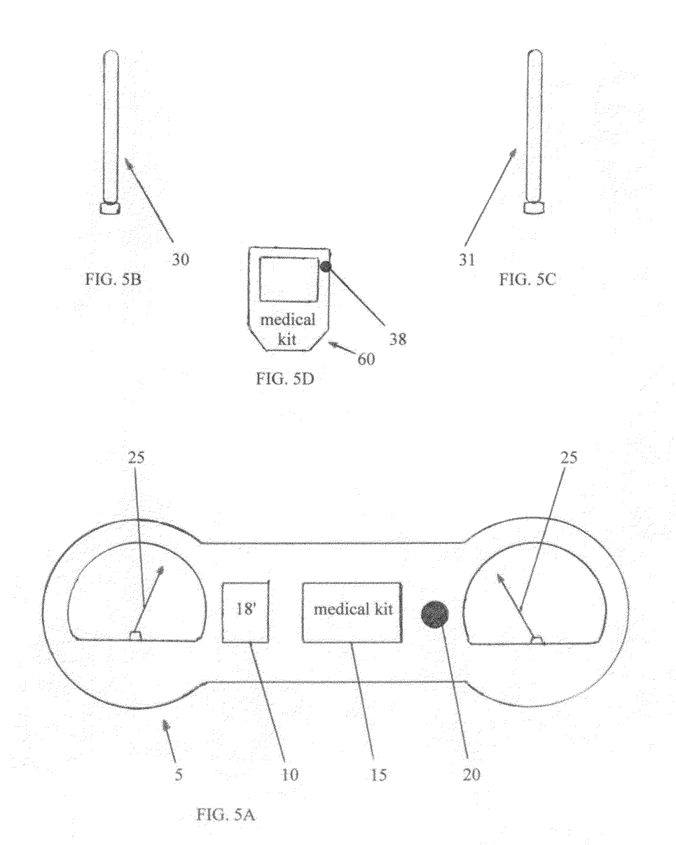

FIG. 6 is an illustration that shows the hand held controller 5, antennas 30, 31 and lost item birth certificate 65. The electromagnetic signature tag 39 is affixed to the birth certificate 65. The pointer needles 25 are pointing to the selected item birth certificate in the selected item window 15. The distance window 10 is displaying 23′, the distance the lost item 65 is from the hand held controller. The selected item knob 20 brings a selected item into the selected item window 15.

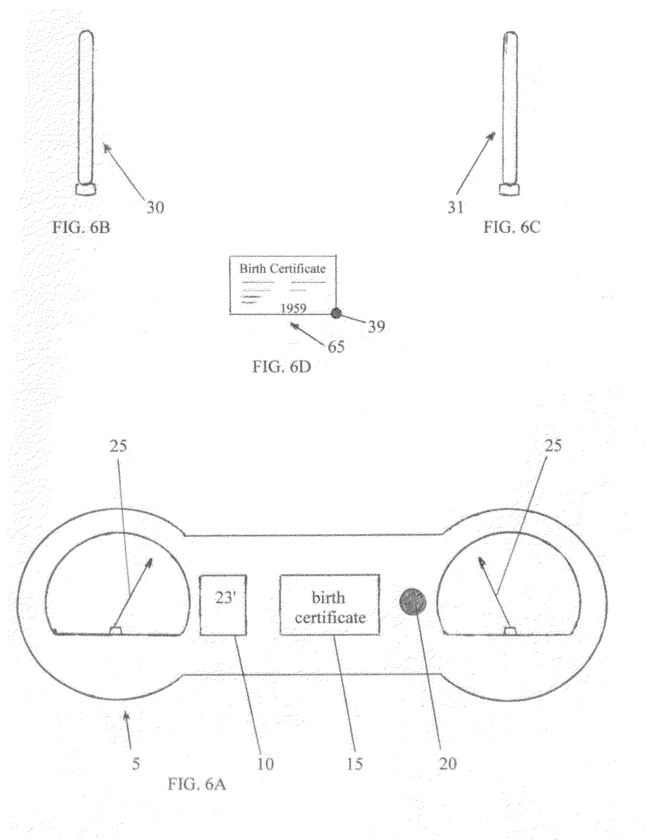

FIG. 7 is an illustration that shows the hand held controller 5, antennas 30, 31 and lost item birth certificate 65. The electromagnetic signature tag 39 is affixed to the birth certificate 65. The birth certificate 65 is located to the left. The pointer needles 25 are pointing to the left in this figure towards the selected item birth certificate 65. The electromagnetic signature tag 35 is affixed to the birth certificate 65. The distance window 10 is displaying 23′. The selected item knob 20 brings the selected item into the selected item window 15. The pointer needles follow the selected item.

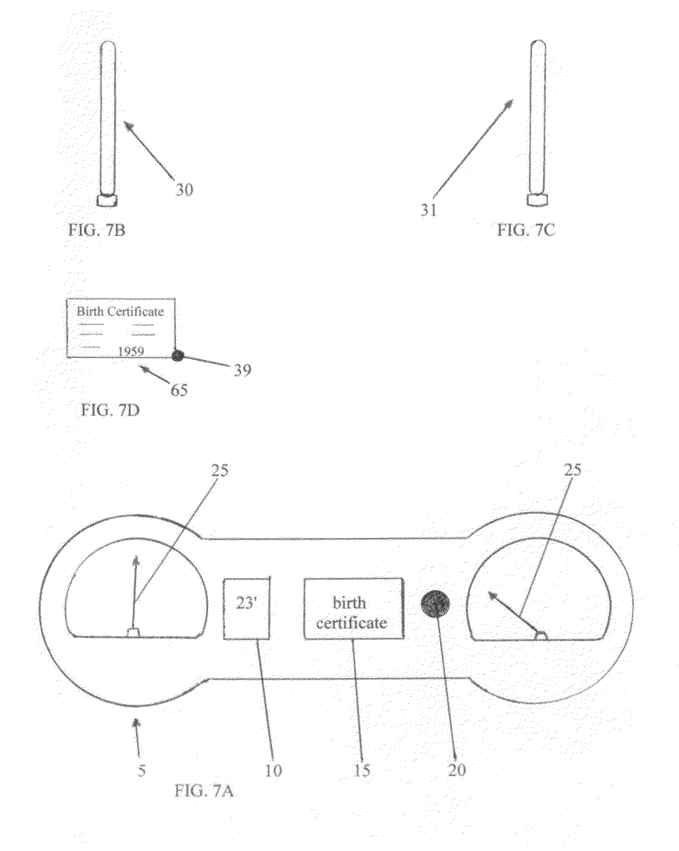

### REFERENCE NUMERALS

5 hand held controller
10 distance window
15 selected item window
20 selected item knob
25 pointer needle
30 antenna #1
31 antenna #2
34 electromagnetic signature tag designated for eyeglasses
35 electromagnetic signature tag designated for i-phone
36 electromagnetic signature tag designated for passport
37 electromagnetic signature tag designated for house keys
38 electromagnetic signature tag designated for medical kit
39 electromagnetic signature tag designated for birth certificate
40 lost item eyeglasses
45 lost item i-phone
50 lost item passport
55 lost item house keys
60 lost item medical kit
65 lost item birth certificate

### DETAILED DESCRIPTION OF THE INVENTION

Scatterbrain is a lost and found machine designed for the household. It consists of the hand held controller 5, there are two antennas approximately 3 feet tall 30, 31. and there are electromagnetic signature tags 34, 35, 36, 37, 38, 39 that are similar size to retail store security tags, approximately dime size. The electromagnetic signature tags, the hand held controller, and the antennas 30, 31 are the lost and found machine. The lost and found machine points towards and displays distance to lost items around the house or apartment.

The electromagnetic signature tags are detected by the hand held controller and and antennas. Transducers within the antennas and hand held controller detect, compare and measure the electromagnetic signature tags. Electromagnetic signature tags are unique from one and other . . . no two are alike.

The hand held controller is approximately the same size as a television remote controller.

There are two antennas, one placed at one end of the house or apartment, the other placed at the other end of the house or apartment. The hand held controller has two pointer needles, both point to the selected item. The hand held controller also shows the distance measured in feet, to the selected item.

Scatterbrain electronically catalogs items, so when they are lost, they are easily found. Anything that is tagged with an electromagnetic signature tag has a corresponding/matching electromagnetic signature logged within the hand held controller. An electromagnetic signature tag is an adhesive tag approximately dime size, discretely adhered to any item. Again, the electromagnetic signature tags are different from one and other. Any ferromagnetic material that comprise the electromagnetic signature tags is accompanied by least one additional ferromagnetic material of a varied amount to give the electromagnetic signature tag its unique signature. All electromagnetic signature tags have a corresponding/matching signature encrypted within the hand held controller.

Any item that you want to be easily found when misplaced, you must tag with an electromagnetic signature tag.

Finding a lost item with the hand held controller is easy.

The antennas 30, 31 placed at opposite ends of the house must always remain in preassigned locations, that is to say, fixed positions. The hand held controller can be moved anywhere. The lost and found machine scatterbrain allows the operator to select in the hand held controller select window an item that has been misplaced. Again, the antennas and hand held controller are calibrated so the antennas remain in a fixed position while the hand held controller can be moved as needed. The hand held controller 5 also has receiving/transmitting antenna within itself as it must communicate with the antennas 30, 31.

The electromagnetic signature of each electromagnet signature tag is unique and is recognized within the hand held controller memory. In other words the hand held controller recognizes one electromagnet signature tag from another. The hand held controller memory has a set of encryptions matching the set of electromagnetic signature tags.

The direction finding capabilities or “DF capabilities” are largely within the antenna housings. Direction finding technology or “DF technology” is used in civil aviation and our military for many decades. The DF information is used for the pointer needles on the hand held controller. The DF information is also used for the distance readout on the hand held controller. Electronic information is exchanged/transmitted between antennas 30, 31, and also the hand held controller 5. DF information from one antenna and DF information from the other antenna are compared within the hand held controller. DF capabilities are also within the hand held controller, giving the pointer needles direction information and also distance information for the distance window of the hand held controller.

An electromagnetic signature from a specific electromagnet signature tag is detected by the antennas 30, 31. Each antenna detects the direction the electromagnetic signature comes from. The direction the electromagnetic signature comes from is broken down into a vertical component and a horizontal component. The two components are a resultant vector. With each antenna 30, 31 having its resultant vector, the location of the electromagnet signature tag is now triangulated, basic trigonometry. The point where the two vectors cross is the point where the electromagnetic signature is located. This information is transmitted to the hand held controller. The hand held controller too has resultant vectors, one from each antenna. With this snapshot of information the hand held controller now displays direction to the point of the electromagnetic signature tag, and distance to the point of the electromagnetic signature tag.

Hand held controller direction and distance information updates continuously, so when the hand held controller is being moved it remains accurate.

Hand held controller resultant vectors from antennas 30, 31 determine a location point. Electromagnetic signature tag resultant vectors from antennas 30, 31 determine a location point.

These two points are continuously updated, as the hand held controller moves, the direction and distance information will change, thus the hand held controller direction and distance readout changes.

If a lost item is under the bed, high on a shelf, or tucked away in a drawer, scatterbrain will point towards and show distance to the lost item. Refer to the drawings for further understanding.

1: Scatterbrain is a lost and found machine that instantly displays the direction towards a lost item around the house or apartment,
the direction towards a lost item is indicated by the pointer needles on the hand held controller,
the instantaneous knowledge of exactly which direction the lost item is located far surpasses the prior art of locating lost items around the house or apartment,
the old way of doing it is to physically pick a half a dozen places the particular lost item has been kept or found before,
maybe you find it and maybe you don't,
any manual location catalog system or file system used to help reduce possible locations of lost items around the house is now antiquated.

2: Scatterbrain is a lost and found machine that instantly displays the distance to a lost item around the house or apartment,
distance to a lost item is indicated in the distance window on the hand held controller,
the instantaneous knowledge of exactly how far the lost item is located far surpasses the prior art of locating lost items around the house or apartment,
the old way of doing it is to physically pick half a dozen places the particular lost item has been kept or found before,
maybe you find it and maybe you don't,
any manual location catalog system or file system used to help reduce possible locations of lost items around the house or apartment is now antiquated.
